(19) United States
(12) Patent Application Publication
(10) Pub. No.: US 2025/0256513 A1
(43) Pub. Date: Aug. 14, 2025

(54) PRINTING APPARATUS, AND CONTROL METHOD FOR PRINTING APPARATUS

(71) Applicant: CANON KABUSHIKI KAISHA, Tokyo (JP)

(72) Inventor: TAKUYA HATAKEYAMA, Kanagawa (JP)

(21) Appl. No.: 19/048,591

(22) Filed: Feb. 7, 2025

(30) Foreign Application Priority Data
Feb. 13, 2024 (JP) 2024-019665

(51) Int. Cl. B41J 2/175

(52) U.S. Cl. CPC B41J 2/17566; B41J 2002/17589

(57) ABSTRACT

A printing apparatus that records, in a case where a remaining amount of a recording material in a consumable product mounted on the printing apparatus is less than a first predetermined amount, notification-transmitted information, to a first storage unit included in the mounted consumable product, and externally transmit a notification requesting a delivery of the consumable product, record the information indicating that the notification has been transmitted as information on the mounted consumable product to a second storage unit included in the printing apparatus, and perform, in a case where the consumable product is removed from the printing apparatus, and the information indicating that the notification has been transmitted is not recorded in the second storage unit, display on a display unit of the printing apparatus indicating that the notification has not been transmitted and prompting a user to mount the consumable product on the printing apparatus.

### BACKGROUND

### Field

The present disclosure relates to a printing apparatus, and a control method for the printing apparatus.

### Description of the Related Art

There exists a service of delivering consumable products to client users of printing apparatuses, such as printers and multifunction peripherals.

Japanese Patent Application Laid-open No. 2019-155742 discusses a technique of preventing a duplicate delivery of a consumable product. In the technique discussed in Japanese Patent Application Laid-open No. 2019-155742, in a case where the remaining amount in a consumable product is small and it is determined that the delivery of the consumable product is required, delivery history information is written in a memory included in the consumable product after transmission of a notification for requesting the delivery to a management server, whereby the duplicate delivery of the consumable product is prevented.

Some printing apparatuses have a configuration in which a consumable product is easily removable. In the case of the apparatus configuration in which the consumable product is easily removable from the printing apparatus, there arises an issue that the consumable product may be removed from the printing apparatus by a user.

In a case where the consumable product is removed from the printing apparatus, there is a possibility that notification transmission of a delivery request may be missed. With the conventional technique, in a case where the consumable product is removed from the printing apparatus before the notification transmission of a delivery request is performed, the notification transmission of a delivery request may not be issued at an appropriate timing. As a result, the consumable product may run out at a timing of using the printing apparatus.

### SUMMARY

According to an aspect of the present disclosure, a printing apparatus including a display unit includes one or more memories storing instructions, and one or more processors that execute the stored instructions, which cause the printing apparatus to record, in a case where a remaining amount of a recording material in a consumable product mounted on the printing apparatus is less than a first predetermined amount, notification-transmitted information indicating that a notification requesting a delivery of the consumable product has been transmitted, to a first storage unit included in the mounted consumable product, and externally transmit the notification, record the information indicating that the notification has been transmitted as information on the mounted consumable product to a second storage unit included in the printing apparatus, based on the information recorded in the first storage unit, and perform, in a case where the consumable product is removed from the printing apparatus, and the information indicating that the notification has been transmitted is not recorded in the second storage unit, display on the display unit of the printing apparatus indicating that the notification has not been transmitted and prompting a user to mount the consumable product on the printing apparatus.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration according to an exemplary embodiment.

FIG. 2 is a diagram illustrating an example of an external appearance of an image forming apparatus according to the present exemplary embodiment.

FIG. 3 is a block diagram illustrating an example of a configuration of a consumable product management server.

FIG. 4 is a block diagram illustrating an example of a configuration of the image forming apparatus according to the present exemplary embodiment.

FIG. 5 is a diagram illustrating an example of a data configuration of information that is stored in each of storage areas in an ink tank non-volatile memory included in an ink tank mountable on the image forming apparatus.

FIG. 6 is a diagram illustrating an example of a data configuration of information that is stored in each of storage areas in a main body non-volatile memory provided in the image forming apparatus.

FIG. 7 is a flowchart illustrating an example of processing that is performed at a delivery timing of an ink tank in the image forming apparatus.

FIG. 8 is a flowchart illustrating an example of processing that is performed in the image forming apparatus when the ink tank is removed.

FIG. 9 is a diagram illustrating an example of a warning screen that is displayed when the ink tank is removed.

FIG. 10 is a diagram illustrating an example of a notification selection screen that is displayed when the ink tank is mounted.

FIG. 11 is a diagram illustrating an example of a notification timing screen on which a setting of a delivery request notification timing based on a remaining amount of each consumable product is changed.

FIG. 12 is a diagram illustrating a change screen on which a setting of a delivery request notification timing for an ink tank of a color is changed.

FIG. 13 is a diagram illustrating an example of a change screen on which a setting of a delivery request notification timing for all colors is changed.

FIG. 14 is a flowchart illustrating an example of processing that is performed to store information on the ink tank non-volatile memory in the main body non-volatile memory provided in the image forming apparatus at predetermined intervals.

FIG. 15 is a flowchart illustrating an example of processing that is performed to update information of an ink remaining amount stored in the ink tank non-volatile memory included in the ink tank.

FIG. 16 is a flowchart illustrating an example of processing that is performed to update information on a start date of use in the ink tank non-volatile memory included in the ink tank.

### DESCRIPTION OF THE EMBODIMENTS

Hereinafter, an exemplary embodiment for implementing the present disclosure will be described with reference to the drawings.

The relative arrangement of the components of the apparatus in the exemplary embodiments, the shape of the apparatus, and the like are merely examples, and the present disclosure is not limited to these. In the accompanying drawings, the same or similar components are denoted by the same reference numerals, and the redundant description will be omitted. In the exemplary embodiments, the printing apparatus (image forming apparatus) is a single-function printer having a printing function, but the printing apparatus is not limited to this.

The printing apparatus may be a copier including a printing function and a reading device for reading an image on a document, or a multi-function peripheral (MFP) including other additional functions.

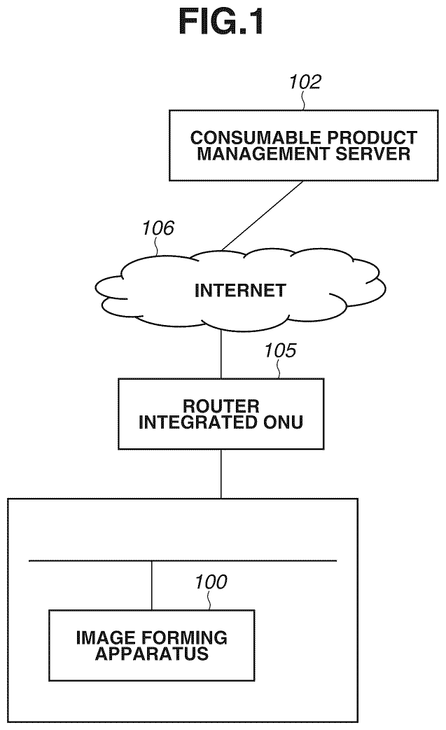

FIG. 1 is a diagram illustrating an example of a system configuration according to an exemplary embodiment of the present disclosure.

An image forming apparatus 100 is a printer or a multifunction peripheral (MFP) serving as an example of a printing apparatus according to the present exemplary embodiment. The image forming apparatus 100 is connected with Internet 106 and a consumable product management server 102 via a router integrated optical network unit (ONU) 105 so that the communication between them is performed.

The router integrated ONU 105 is connected to the Internet 106 via an optical line. The ONU is a terminal device of an optical line and has a function of mutually converting an optical signal of the optical line and an electrical digital signal.

The consumable product management server 102 is connected to the Internet 106. The consumable product management server 102 is includes a storage device described below and stores and manages data of start date of use information, remaining amount information, and delivery information, of various kinds of consumable products for each image forming apparatus managed thereby. The printing method of the image forming apparatus 100 in the present exemplary embodiment may be an electrophotographic method or an inkjet method and may be other methods. The consumable product that is a delivery target in the present exemplary embodiment is mainly a recording material container. More specifically, the recording material container is an ink cartridge, an ink tank, an ink bottle, a toner bottle, or a toner cartridge. The recording material container includes a non-volatile memory, and reading out from and writing to the non-volatile memory are possible by a control of a central processing unit (CPU) of the image forming apparatus 100 in a state where the recording material container is mounted on the image forming apparatus 100. The details will be described below.

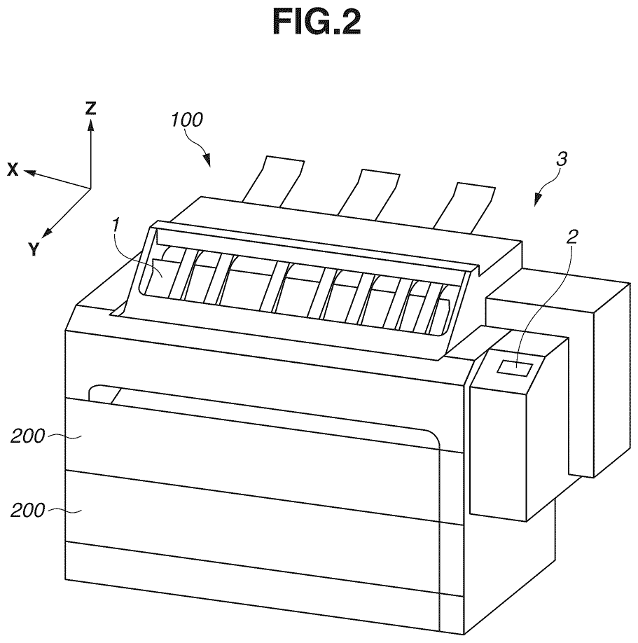

FIG. 2 is a diagram illustrating an example of an external appearance of the image forming apparatus 100. The image forming apparatus 100 is merely an example of the present exemplary embodiment.

Two rolls of paper with a sheet 1 wound in a roll shape is set to the image forming apparatus 100. The image forming apparatus 100 prints an image on the sheet 1 pulled out from a roll of paper selected from the two rolls of paper set in sheet feed devices 200 that are disposed one above the other. The sheet 1 on which printing has been performed is discharged to a stacker 3 disposed on an upper part of the image forming apparatus 100. A user inputs various kinds of commands, such as a size designation of the sheet 1, a switching between on-line and off-line, a setting of a paper discharge destination, and a switching between power on and off, to the image forming apparatus 100 by using various kinds of switches disposed on an operation panel 2.

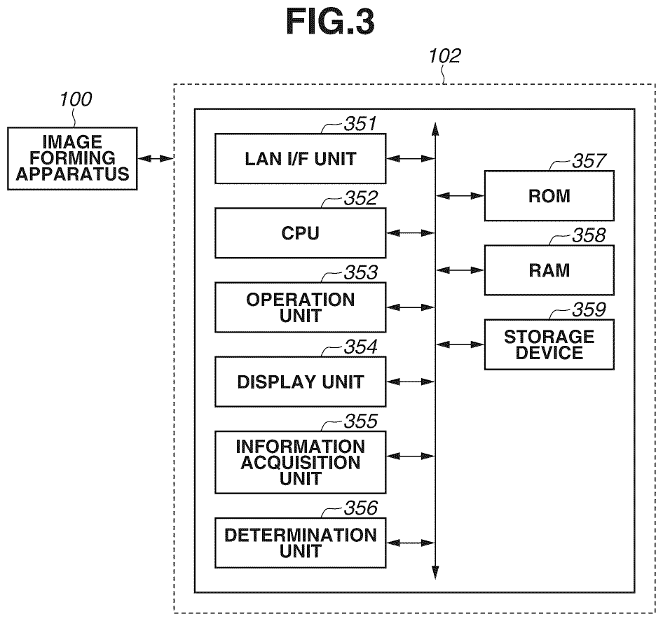

FIG. 3 is a block diagram illustrating an example of a configuration of the consumable product management server 102.

The consumable product management server 102 includes a CPU 352, a read only memory (ROM) 357, a random access memory (RAM) 358, a storage device 359, a local area network interface (LAN I/F) unit 351, an operation unit 353, a display unit 354, and the like.

The ROM 357 is a non-volatile memory for storing various kinds of programs that operate on the consumable product management server 102, and data. The RAM 358 is a volatile memory that is used as a temporary work area by the CPU 352 executing various kinds of programs. The storage device 359 includes, for example, a plurality of hard disk drives configuring a redundant array of inexpensive disks (RAID) and stores various kinds of data. The CPU 352 reads out a program from the ROM 357 or the storage device 359 to the RAM 358 and executes the read program to control the consumable product management server 102.

The LAN I/F unit 351 is an interface with an externally connected device via a network. The consumable product management server 102 is connected with the image forming apparatus 100 via the LAN I/F unit 351 to exchange execution commands or data with the image forming apparatus 100.

The operation unit 353 includes a plurality of switches including a power key. The display unit 354 includes a plurality of light-emitting diodes (LEDs).

An information acquisition unit 355 and a determination unit 356 are functions implemented by software and are realized by the CPU 352 reading out a program from the ROM 357 or the storage device 359 to the RAM 358 and executing the read program. The information acquisition unit 355 communicates with the image forming apparatus 100 via the LAN I/F unit 351 at any timing, to receive a delivery request notification (notification about a delivery request of a consumable product), or to acquire information about a start date of use of each consumable product in the image forming apparatus 100, a remaining amount, the number of times of mounting the consumable product, and a delivery request notification transmitted flag. These pieces of information are acquired using command communications defined uniquely by each maker. The determination unit 356 determines the delivery of the consumable product, based on the information acquired by the information acquisition unit 355. While not illustrated, the consumable product management server 102 includes various functions implemented by software, in addition to the information acquisition unit 355 and the determination unit 356.

The consumable product management server 102 may be achieved by one computer, or a plurality of computers. For example, the consumable product management server 102 may have a configuration achieved using a cloud computing technology.

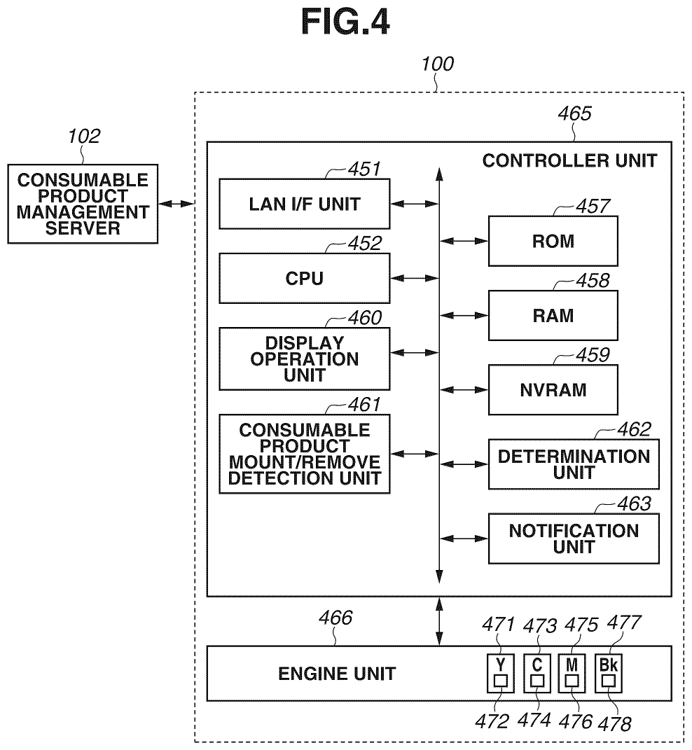

FIG. 4 is a block diagram illustrating an example of a configuration of the image forming apparatus 100.

The image forming apparatus 100 includes a controller unit 465 for printing and an engine unit 466.

The controller unit 465 includes a LAN I/F unit 451, a CPU 452, a ROM 457, a RAM 458, a non-volatile RAM (NVRAM) 459, a display operation unit 460, and a consumable product mount/remove detection unit 461.

The ROM 457 is a non-volatile memory for storing a control execution code (program), data, and the like, for the image forming apparatus 100. The RAM 458 is a volatile memory that is used as a temporary working memory by the CPU 452 executing various kinds of programs and temporarily stores image data for printing when the CPU 452 executes control of the image forming apparatus 100. The NVRAM 459 is a non-volatile memory for storing records of various kinds of data to be used for maintenance of the image forming apparatus 100 or information on images for printing. The CPU 452 reads out a program to the RAM 458 from the ROM 457 or the like and executes the read program to control the image forming apparatus 100.

The LAN I/F unit 451 is an interface with an externally connected device via a network. The image forming apparatus 100 is connected with the consumable product management server 102 via the LAN I/F unit 451 to exchange execution commands or data with the consumable product management server 102.

The display operation unit 460 includes a user interface, such as a liquid crystal display (LCD), LEDs, keys, and a touch panel. The user performs an execution operation and a setting operation of each function of the image forming apparatus 100 by using the display operation unit 460. The CPU 452 controls an operation state and a display content of the display operation unit 460. The consumable product mount/remove detection unit 461 uses a sensor to detect whether a consumable product is mounted or removed.

While, in the present exemplary embodiment, descriptions are given using an image forming apparatus that uses four color inks of black (Bk), cyan (C), magenta (M), and yellow (Y), the number of ink colors may be any number of colors. As described above, recording materials other than ink may be used.

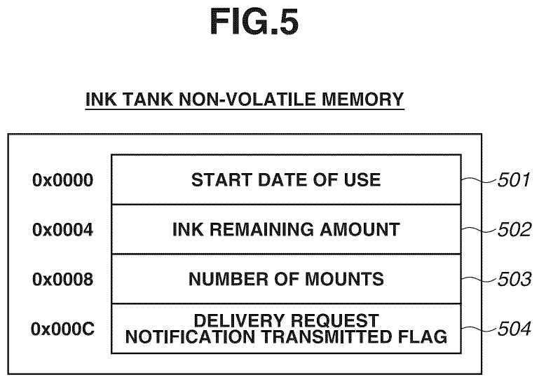

On the engine unit 466, a Y ink tank 471, a C ink tank 473, an M ink tank 475, and a Bk ink tank 477 are removably mounted. Each of the ink tanks includes an ink tank non-volatile memory as illustrated in FIG. 5 described below. The Y ink tank 471 includes a Y ink tank non-volatile memory 472, the C ink tank 473 includes a C ink tank non-volatile memory 474, the M ink tank 475 includes an M ink tank non-volatile memory 476, and the Bk ink tank 477 includes a Bk ink tank non-volatile memory 478. Via the engine unit 466, the CPU 452 reads and writes information as illustrated in FIG. 5 described below from and to the non-volatile memory included in each of the ink tanks attached to the engine unit 466. While components of ink contained in each of the ink tanks is not specifically limited, in the present exemplary embodiment, the ink is an aqueous pigment ink including pigment serving as a color material, water, and resin.

A determination unit 462 and a notification unit 463 are functions implemented by software and realized by the CPU 452 reading out a program from the ROM 457 or the like to the RAM 358 and executing the read program. When the consumable product is removed from the image forming apparatus 100, the determination unit 462 determines whether a delivery request notification flag regarding the removed consumable product stored in a main body non-volatile memory is valid (ON) or invalid (OFF). In a case where the determination unit 462 determines that the delivery request notification flag in the main body non-volatile memory is invalid (OFF), the notification unit 463 issues a warning to the user. Although not illustrated, the image forming apparatus 100 has various kinds of functions implemented by software, in addition to the determination unit 462 and the notification unit 463.

FIG. 5 is a diagram illustrating an example of a data configuration of information stored in each of storage areas in the non-volatile memory included in the ink tank mountable on the image forming apparatus 100.

A start date of use 501 is a storage area where a start date and time of use of the ink tank is stored, and date and time information on the date and time when the ink tank is mounted on the image forming apparatus 100 is recorded.

An ink remaining amount 502 is a storage area where an ink remaining amount is stored. While the ink remaining amount is 100% when a new ink tank is mounted, the remaining amount reduces as the printing that consumes ink is performed, and when the ink tank is empty, the remaining amount reaches 0%.

A number of mounts 503 is a storage area where the number of times that the ink tank has been mounted is stored. When a new ink tank is mounted, the first count is performed, and when the ink tank is removed once and mounted again, the count value also increments.

A delivery request notification transmitted flag 504 is a storage area where whether an ink tank delivery request notification has been sent to the consumable product management server 102 is stored. The delivery request notification transmitted flag 504 is “0” indicating “OFF” that is an initial value in a state where the notification (delivery request notification) serving as a trigger of the delivery is not transmitted, and when the notification serving as the trigger of the delivery is performed, “1” is written therein.

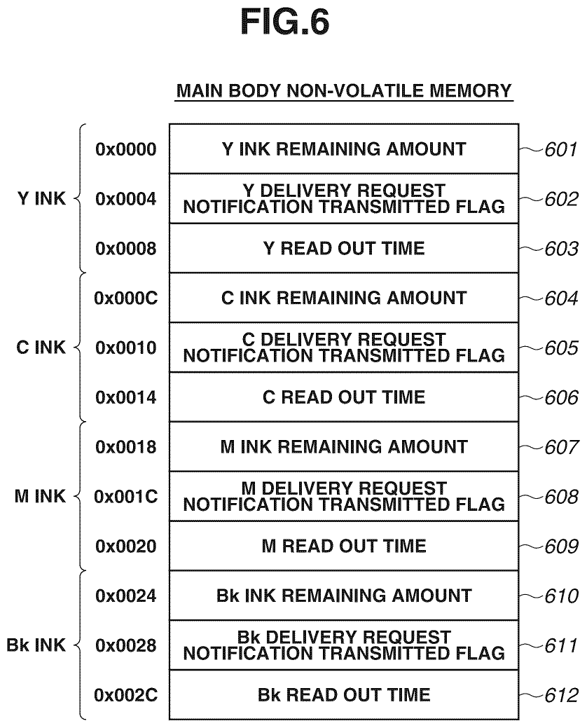

FIG. 6 is a diagram illustrating an example of a data configuration of information that is stored in each of storage areas of the main body non-volatile memory (NVRAM 459) included in the image forming apparatus 100.

As illustrated in FIG. 6, an ink remaining amount, a delivery request notification transmitted flag, and a read out time are stored for each ink color in predetermined storage areas of the main body non-volatile memory. While the Y ink is described below as a representative example, descriptions of other color inks, such as the C ink, the M ink, and the Bk ink, are similar to that of the Y ink.

A Y ink remaining amount 601 is ink remaining amount information on the Y ink. A Y delivery request notification transmitted flag 602 is a delivery request notification transmitted flag of the Y ink. In the Y ink remaining amount 601 and the Y delivery request notification transmitted flag 602, values read from the Y ink tank non-volatile memory at a predetermined cycle are stored. The time when these values are read out is stored in an area indicated by a Y read out time 603.

Descriptions about a C ink remaining amount 604, a C delivery request notification transmitted flag 605, a C read out time 606, an M ink remaining amount 607, an M delivery request notification transmitted flag 608, an M read out time 609, a Bk ink remaining amount 610, a Bk delivery request notification transmitted flag 611, and a Bk read out time 612 are omitted because they are similar to the descriptions of the Y ink remaining amount 601, the Y delivery request notification transmitted flag 602, and the Y read out time 603, respectively.

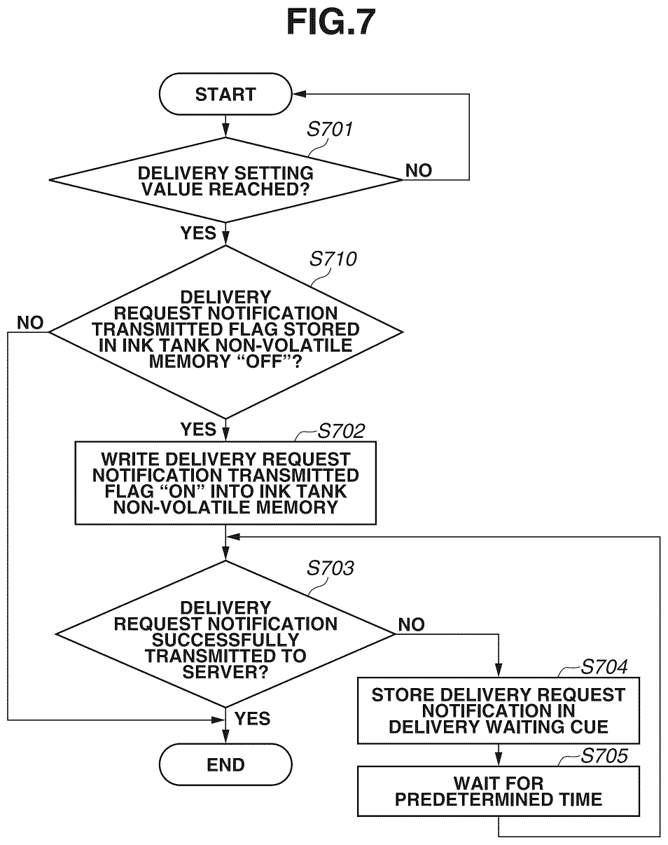

Hereinbelow, with reference to FIG. 7, processing of a delivery timing of an ink tank in the image forming apparatus 100 according to the present exemplary embodiment will be described below.

FIG. 7 is a flowchart illustrating an example of processing that is performed at a delivery timing of an ink tank in the image forming apparatus 100. The processing of this flowchart is implemented by the CPU 452 reading out a program from the ROM 457 or the like to the RAM 358 and executing the read program. The processing of this flowchart is periodically executed for each ink tank mounted on the image forming apparatus 100. The execution timings of the processing for the ink tanks may be the same or different. The term “periodically” may also refer to a case in which the execution timing is at a predetermined time intervals or each time the predetermined amount of printing is performed.

In step S701, the CPU 452 of the image forming apparatus 100 acquires the ink remaining amount 502 from the ink tank non-volatile memory of the processing target ink tank (hereinbelow, referred to as a target ink tank) and determines whether the ink remaining amount has reached a delivery setting value. The delivery setting value is set in advance and stored in the NVRAM 459 or the like.

In step S701, in a case where the CPU 452 determines that the ink remaining amount has not reached the delivery setting value (NO in step S701), the CPU 452 repeats the processing in step S701 to perform control to continue monitoring of the ink remaining amount of the target ink tank.

In a case where the CPU 452 determines that the ink remaining amount has reached the delivery setting value (YES in step S701), the CPU 452 advances the processing to step S710.

In step S710, the CPU 452 determines whether the delivery request notification transmitted flag 504 stored in the ink tank non-volatile memory of the target ink tank is “OFF”.

In step S710, in a case where the CPU 452 determines that the delivery request notification transmitted flag 504 is “ON” (NO in step S710), the CPU 452 ends the processing of this flowchart.

In a case where the CPU 452 determines that the delivery request notification transmitted flag 504 is “OFF” (YES in step S710), the CPU 452 advances the processing to step S702.

In step S702, the CPU 452 writes “ON” to the delivery request notification transmitted flag 504 in the ink tank non-volatile memory of the target ink tank and advances the processing to step S703.

In step S703, the CPU 452 transmits a delivery request notification to the consumable product management server 102 and determines whether the delivery request notification has been successfully transmitted.

In step S703, in a case where the CPU 452 determines that the delivery request notification has not been transmitted successfully (NO in step S703), the CPU 452 advances the processing to step S704. In step S704, the CPU 452 stores the delivery request notification in a delivery waiting cue (e.g., set in the RAM 458), and then advances the processing to step S705. In step S705, the CPU 452 waits for a predetermined time (e.g., 10 minutes) and then returns the processing to step S703.

In a case where the CPU 452 determines that the delivery request notification has been successfully transmitted (YES in step S703), the CPU 452 ends the processing of this flowchart. In this way, the series of steps ends.

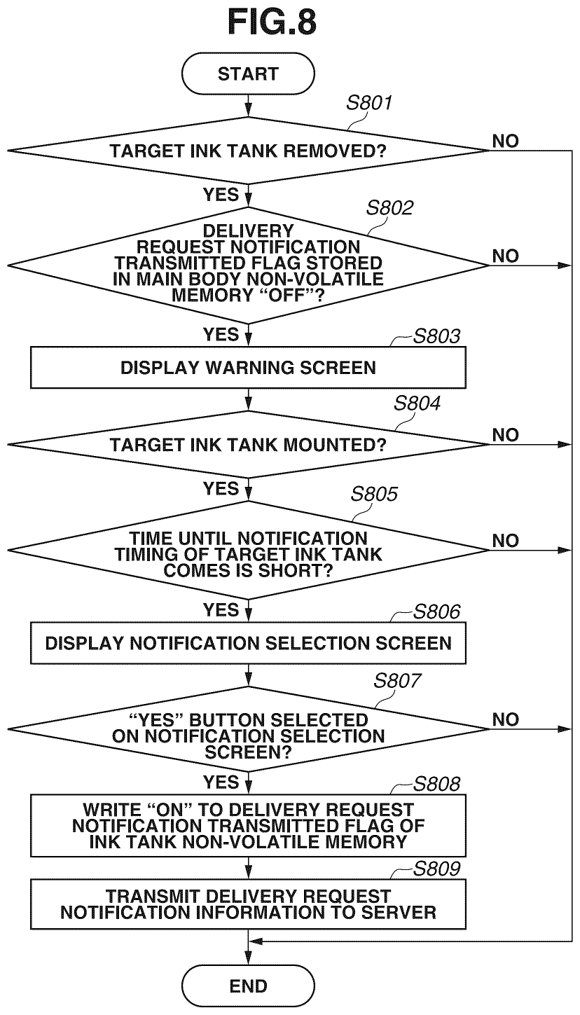

Hereinbelow, with reference to FIG. 8, processing that is performed when an ink tank has been removed from the image forming apparatus 100 according to the present exemplary embodiment will be described.

FIG. 8 is a flowchart illustrating an example of processing that is performed when the ink tank has been removed from the image forming apparatus 100. The processing of this flowchart is implemented by the CPU 452 reading out a program from the ROM 457 or the like to the RAM 358 and executing the read program. The processing of this flowchart is periodically performed for each of the ink tanks mounted on the image forming apparatus 100. The execution timing of the processing for each of the ink tanks may be the same or different. The term “periodically” may also refer to a case in which the execution timing is at a predetermined time intervals or each time the predetermined amount of printing is performed.

In step S801, via the consumable product mount/remove detection unit 461, the CPU 452 of the image forming apparatus 100 determines whether a processing target ink tank (hereinbelow, referred to as a target ink tank) has been removed.

In step S801, in a case where the CPU 452 determines that the target ink tank has not been removed (NO in step S801), the CPU 452 ends this flowchart.

In a case where the CPU 452 determines that the target ink tank has been removed (YES in step S801), the CPU 452 advances the processing to step S802. Alternatively, in response to the target ink tank being removed, an interrupt signal may be input to the CPU 452 from the consumable product mount/remove detection unit 461, and the CPU 452 may execute the processing in step S802 and the subsequent steps.

In step S802, the CPU 452 determines whether the delivery request notification transmitted flag of the target color ink tank (any one of Y delivery request notification transmitted flag 602, C delivery request notification transmitted flag 605, M delivery request notification transmitted flag 608, and Bk delivery request notification transmitted flag 611 in FIG. 6) stored in the main body non-volatile memory of the image forming apparatus 100 is “OFF”.

In step S802, in a case where the CPU 452 determines that the delivery request notification transmitted flag of the target color ink tank is “ON” (NO in step S802), the CPU 452 ends the processing of this flowchart.

In a case where the CPU 452 determines that the delivery request notification transmitted flag of the target color ink tank is “OFF” (YES in step S802), the CPU 452 advances the processing to step S803.

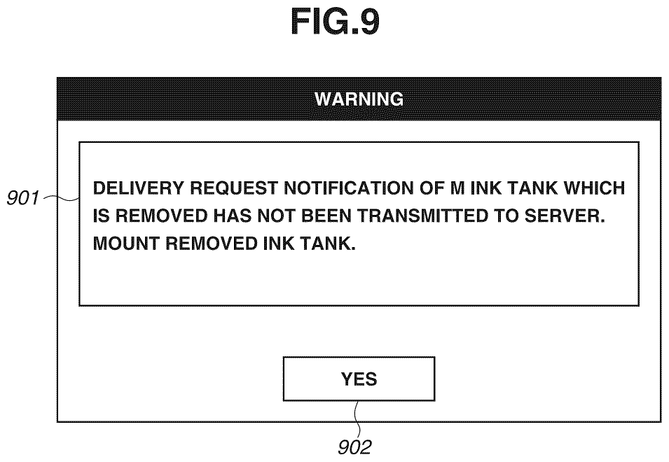

In step S803, the CPU 452 displays a warning screen as illustrated in FIG. 9 on the display operation unit 460. Details of this warning screen will be described with reference to FIG. 9.

FIG. 9 is a diagram illustrating an example of the warning screen that is displayed when the ink tank has been removed in step S803 in FIG. 8.

On the warning screen in FIG. 9, a warning prompt 901 is a message to warn that the delivery request notification of the removed color ink tank has not been transmitted to the consumable product management server 102, and prompts the user to mount the removed ink tank. A YES button 902 is a button to be pressed by the user when the user has acknowledged the warning prompt 901. In response to detection of the pressing performed on the YES button 902, the CPU 452 advances the processing to step S804 in FIG. 8.

In step S804, via the consumable product mount/remove detection unit 461, the CPU 452 determines whether the target ink tank has been mounted.

In step S804, in a case where the CPU 452 determines that the target ink tank has not been mounted (NO in step S804), the CPU 452 ends the processing of this flowchart.

In a case where the CPU 452 determines that the target ink tank has been mounted (YES in step S804), the CPU 452 advances the processing to step S805.

In step S805, the CPU 452 determines whether the time until the notification timing of the mounted target ink tank comes is short. This determination is performed by the CPU 452 acquiring the value of the ink remaining amount 502 from the ink tank non-volatile memory of the target ink tank and determining whether the difference between the ink remaining amount and the above-described delivery setting value is less than a predetermined value. In a case where the above-described difference is less than the predetermined value, the CPU 452 determines that the time until the notification timing comes is short.

In step S805, in a case where the CPU 452 determines that the time until the notification timing comes is not short (NO in step S805), the CPU 452 ends the processing.

In a case where the CPU 452 determines that the time until the notification timing comes is short (YES in step S805), the CPU 452 advances the processing to step S806.

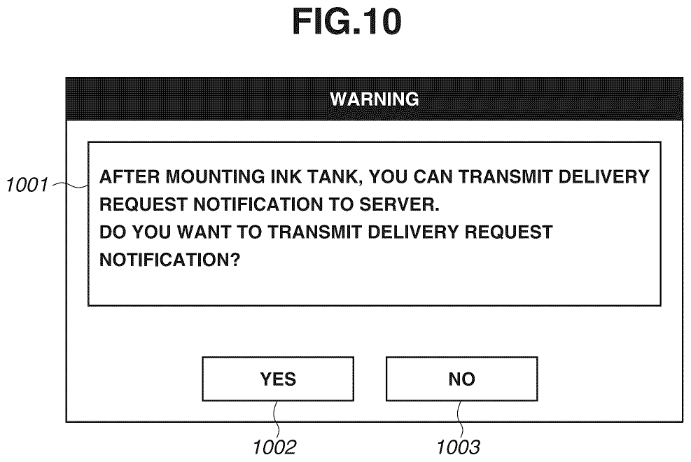

In step S806, the CPU 452 displays a notification selection screen as illustrated in FIG. 10 on the display operation unit 460. Details of this notification selection screen will be described with reference to FIG. 10.

FIG. 10 is a diagram illustrating an example of the notification selection screen displayed in step S806 in FIG. 8 when the ink tank is mounted.

In FIG. 10, a confirmation prompt 1001 is a message asking the user whether to transmit the delivery request notification of the target ink tank to the consumable product management server 102. A YES button 1002 is selected by the user in a case where the delivery request notification is to be transmitted to the consumable product management server 102. A NO button 1003 is selected by the user in a case where the delivery request notification is not to be transmitted to the consumable product management server 102. In response to the YES button 1002 or the NO button 1003 being pressed, the CPU 452 advances the processing to step S807 in FIG. 8.

In step S807, the CPU 452 determines whether transmitting the delivery request notification is selected i.e., the YES button 1002 is pressed, on the notification selection screen displayed in step S806 described above.

In step S807, in a case where the CPU 452 determines that not transmitting the delivery request notification is selected, i.e., the NO button 1003 is pressed (NO in step S807), the CPU 452 ends the processing of this flowchart.

In a case where the CPU 452 determines that transmitting the delivery request notification is selected, i.e., the YES button 1002 is pressed (YES in step S807), the CPU 452 advances the processing to step S808.

In step S808, the CPU 452 writes “ON” to the delivery request notification transmitted flag 504 in the ink tank non-volatile memory of the target ink tank and advances the processing to step S809.

In step S809, the CPU 452 transmits delivery request notification information to the consumable product management server 102 and ends the processing of this flowchart. In this way, the series of steps ends.

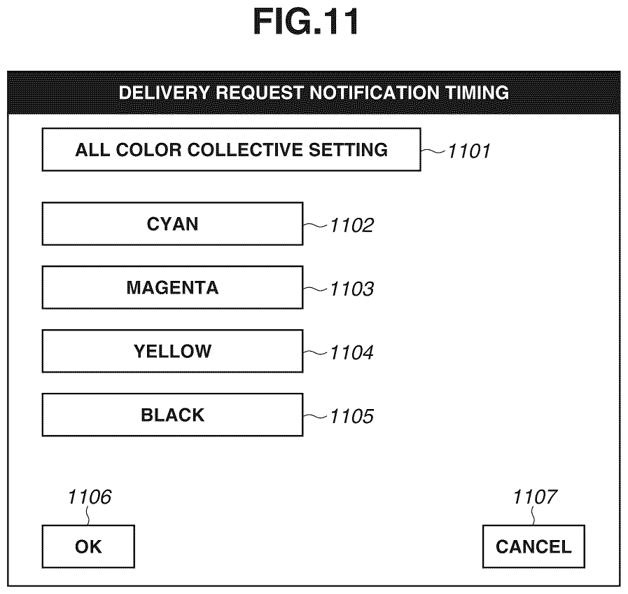

With reference to FIGS. 11 to 13, a function of changing a delivery request notification timing based on the remaining amount of each consumable product will be described.

FIG. 11 is a diagram illustrating an example of a delivery request notification timing screen on which a setting of the delivery request notification timing based on the remaining amount of each consumable product is changed. This screen is displayed on the display operation unit 460 in response to a predetermined user's operation to the display operation unit 460.

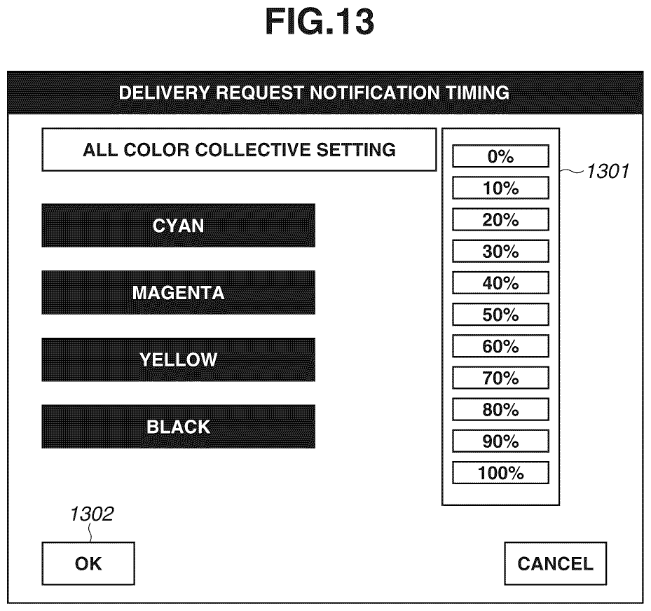

On the delivery request notification timing screen in FIG. 11, an all color collective setting button 1101 is used to collectively change the notification timings of all ink colors. In response to the button being pressed, a screen illustrated in FIG. 13 is displayed on the display operation unit 460.

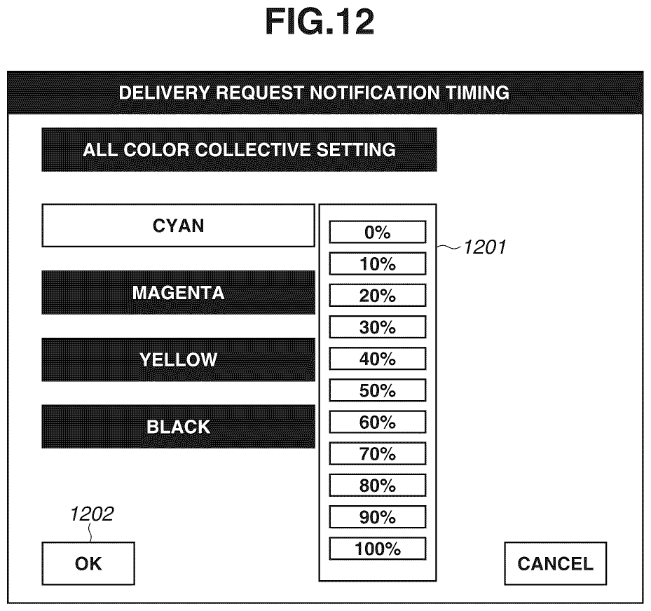

A cyan button 1102, a magenta button 1103, a yellow button 1104, and a black button 1105 are buttons each of which are used to change the notification timing for the corresponding ink color. In response to any of these buttons being pressed, a screen illustrated in FIG. 12 is displayed on the display operation unit 460.

An OK button 1106 is used to apply the setting value change on a display screen of a liquid crystal panel for changing the delivery request notification timing. In response to the button being pressed, the delivery request notification timing is changed.

A cancel button 1107 is used to cancel the setting value change without applying the setting value change performed on the display screen of the liquid crystal panel for changing the delivery request notification timing. In response to the button being pressed, the delivery request notification timing change is not performed, and the setting change is discarded.

FIG. 12 is a diagram illustrating an example of a change screen on which a setting of a delivery request notification timing for each individual color ink tank is changed. In FIG. 12, as an example, a screen for changing the delivery request notification timing of the C ink tank 473 is illustrated as a representative. More specifically, the example in which a button with a name of Cyan (i.e., “Cyan” button 1102) is pressed on the delivery request notification timing screen in FIG. 11 described above is illustrated.

For example, the user selects an option value on the change screen for one color from selection option setting values in 10% increments, such as 0%, 10%, 20%, 30%, 40%, 50%, 60%, 70%, 80%, 90%, and 100% as illustrated in a selection field 1201. While, in the present exemplary embodiment, the example of 10% increments is used, any numeral value increments, such as 15% and 76% other than 10% increments, may be used. For example, in a case where the option “20%” is selected in the selection field 1201 and an OK button 1202 is pressed, a timing at which the ink remaining amount of the target color ink tank reaches “20%” or less of the full state is set as the delivery request notification timing.

FIG. 13 is a diagram illustrating an example of a change screen for collectively changing the delivery request notification timings for all colors. In FIG. 13, a case in which the all color collective setting button 1101 is pressed on the delivery request notification timing screen in FIG. 11 described above is illustrated as an example.

For example, the user selects an option value on the all color collective change screen from the selection option setting values in 10% increments, such as 0%, 10%, 20%, 30%, 40%, 50%, 60%, 70%, 80%, 90%, and 100% as illustrated in a selection field 1301. While, in the present exemplary embodiment, the example of 10% increments is used, any numeral value increments, such as 15% and 76% other than 10% increments, may be used. For example, in a case where an option “30%” is selected in the selection field 1301 and an OK button 1302 is pressed, a timing at which the ink remaining amount of any of the color ink tanks reaches “30%” or less of the full state is set as the delivery request notification timing.

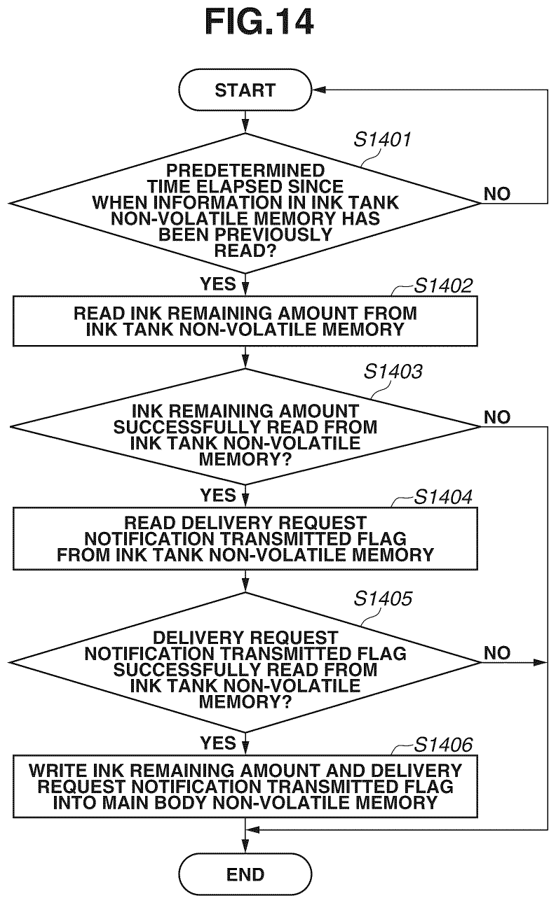

With reference to FIG. 14, processing of storing information stored in the non-volatile memory of the ink tank at predetermined intervals in the non-volatile memory (main body non-volatile memory) of the image forming apparatus will be described.

FIG. 14 is a flowchart illustrating an example of processing that is performed to store information stored in the ink tank non-volatile memory in the non-volatile memory (main body non-volatile memory) in the image forming apparatus 100 at predetermined intervals. The processing of this flowchart is implemented by the CPU 452 reading out a program from the ROM 457 or the like to the RAM 358 and executing the read program. The processing of this flowchart is executed for each ink tank mounted on the image forming apparatus 100. The execution timing of the processing for each of the ink tanks may be the same or different.

In step S1401, the CPU 452 of the image forming apparatus 100 determines whether a predetermined time (e.g., 5 minutes) has elapsed since when the information in the ink tank non-volatile memory, which is a processing target ink tank (hereinbelow, referred to as a target ink tank), has been previously read and stored in the main body non-volatile memory of the image forming apparatus 100. More specifically, the CPU 452 determines whether the predetermined time has elapsed from the read time of a target color ink corresponding to the target ink tank stored in the non-volatile memory of the image forming apparatus 100 (from any of the Y read out time 603, C read out time 606, M read out time 609, and Bk read out time 612 in FIG. 6). While, in the present exemplary embodiment, an example in which the predetermined time interval is 5 minutes is described, the predetermined time interval may be any time interval, such as 1 minute, 10 minutes, 20 minutes, and 1 hour.

In step S1401, in a case where the CPU 452 determines that the predetermined time has not elapsed yet (NO in step S1401), the CPU 452 repeats the processing in step S1401 to perform control to continue checking the elapse of the predetermined time.

In a case where the CPU 452 determines that the predetermined time has elapsed (YES in step S1401), the CPU 452 advances the processing to step S1402.

In step S1402, the CPU 452 reads information on the ink remaining amount 502 in the non-volatile memory of the target ink tank and stores the read information in the RAM 458.

In step S1403, the CPU 452 determines whether the ink remaining amount is successfully read from the ink tank non-volatile memory in step S1402 described above.

In step S1403, in a case where the CPU 452 determines that the ink remaining amount has not been successfully read (NO in step S1403), the CPU 452 ends the processing of this flowchart.

In a case where the CPU 452 determines that the ink remaining amount has been successfully read (YES in step S1403), the CPU 452 advances the processing to step S1404.

In step S1404, the CPU 452 reads the information on the delivery request notification transmitted flag 504 from the target ink tank non-volatile memory and stores the read information in the RAM 458.

In step S1405, the CPU 452 determines whether the delivery request notification transmitted flag 504 has been successfully read from the non-volatile memory of the ink tank in step S1404 described above.

In step S1405, in a case where the CPU 452 determines that the delivery request notification transmitted flag 504 has not been successfully read (NO in step S1405), the CPU 452 ends the processing of this flowchart.

In a case where the CPU 452 determines that the delivery request notification transmitted flag 504 has been successfully read (YES in step S1405), the CPU 452 advances the processing to step S1406.

In step S1406, the CPU 452 writes the information on the ink remaining amount and the information on the delivery request notification transmitted flag 504 stored in the RAM 458 in steps S1402 and S1404 in the non-volatile memory (NVRAM 459) of the image forming apparatus 100 described with reference to FIG. 6. Then, the processing of this flowchart ends. In step S1406, as the information on the consumable product (ink tank) identified by the target ink color, for example, the information on the ink remaining amount and the delivery request notification transmitted flag 504 is stored in the main body non-volatile memory. In identifying the consumable product, the consumable product may be managed using a unique identification number of each ink tank other than the color.

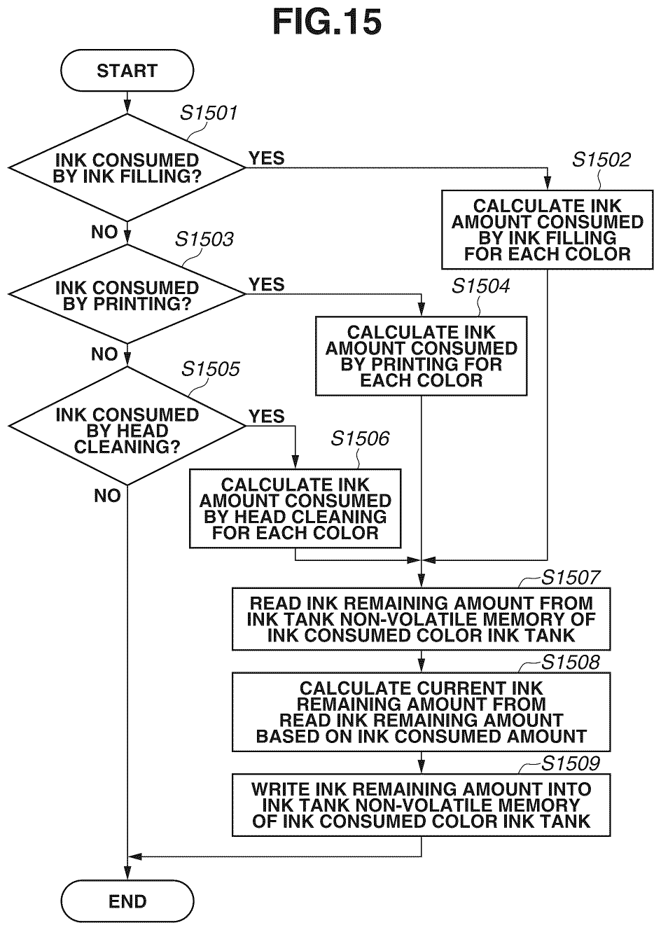

With reference to FIG. 15, processing of updating the information on the ink remaining amount 502 in the non-volatile memory include in the ink tank illustrated in FIG. 5 will be described.

FIG. 15 is a flowchart illustrating an example of processing of updating the information on the ink remaining amount 502 in the non-volatile memory included in the ink tank. The processing of this flowchart is implemented by the CPU 452 reading out a program from the ROM 457 or the like to the RAM 358 and executing the read program. The processing of this flowchart is performed periodically. The term “periodically” may also refer to a case in which the execution timing is at a predetermined time intervals or each time the predetermined amount of printing is performed.

In step S1501, the CPU 452 of the image forming apparatus 100 checks whether ink is consumed by ink filling.

In step S1501, in a case where the CPU 452 determines that the ink is consumed by the ink filling (YES in step S1501), the CPU 452 advances the processing to step S1502. In step S1502, the CPU 452 calculates the ink amount consumed by the ink filling for each color, and then advances the processing to step S1507.

The processing to be performed in step S1507 and the subsequent steps will be described below.

In a case where the CPU 452 determines that the ink is not consumed by the ink filling (NO in step S1501), the CPU 452 advances the processing to step S1503.

In step S1503, the CPU 452 checks whether ink is consumed by printing.

In step S1503, in a case where the CPU 452 determines that the ink is consumed by the printing (YES in step S1503), the CPU 452 advances the processing to step S1504. In step S1504, the CPU 452 calculates the ink amount consumed by the printing for each color, and then advances the processing to step S1507.

In a case where the CPU 452 determines that the ink is not consumed by the printing (NO in step S1503), the CPU 452 advances the processing to step S1505. In step S1505, the CPU 452 checks whether ink is consumed by head cleaning.

In step S1505, in a case where the CPU 452 determines that the ink is consumed by the head cleaning (YES in step S1505), the CPU 452 advances the processing to step S1506. In step S1506, the CPU 452 calculates the ink amount consumed by the head cleaning for each color, and then advances the processing to step S1507.

In a case where the ink is not consumed by the head cleaning (NO in step S1505), the CPU 452 ends the processing of this flowchart.

After the calculation of each of the ink consumed amounts in steps S1502, S1504, and S1506, then in step S1507, the CPU 452 reads out the ink remaining amount 502 from the non-volatile memory included in the ink tank of the color with the ink consumed therefrom.

In step S1508, the CPU 452 calculates a current ink remaining amount based on the ink remaining amount read in step S1507 described above and the calculated ink consumed amount described above.

In step S1509, the CPU 452 executes writing processing of the ink remaining amount calculated in step S1508 described above in the non-volatile memory included in the ink-consumed color ink tank, and then ends the processing of this flowchart.

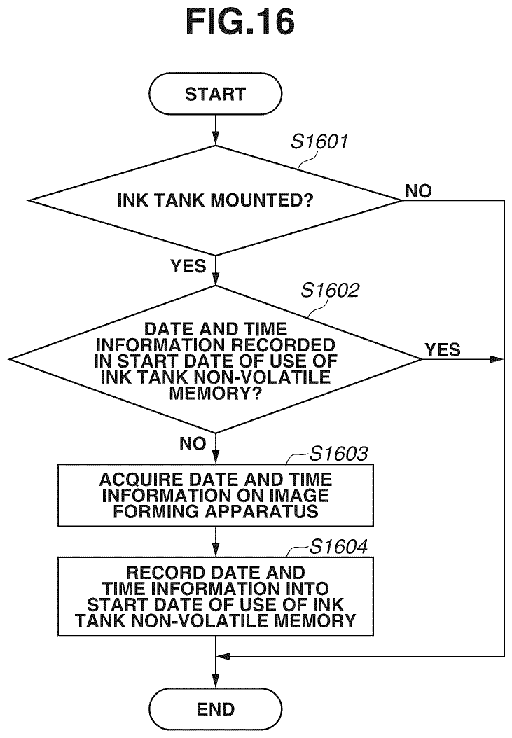

With reference to FIG. 16, processing of updating information on the start date of use 501 stored in the non-volatile memory included in the ink tank illustrated in FIG. 5 will be described.

FIG. 16 is a flowchart illustrating an example of processing of updating the information on the start date of use 501 in the non-volatile memory included in the ink tank. The processing of this flowchart is implemented by the CPU 452 reading out a program from the ROM 457 or the like to the RAM 358 and executing the read program. The processing of this flowchart is performed periodically.

In step S1601, via the consumable product mount/remove detection unit 461, the CPU 452 of the image forming apparatus 100 determines whether a processing target ink tank (hereinbelow, referred to as a target ink tank) has been mounted.

In step S1601, in a case where the CPU 452 determines that the target ink tank has not been mounted (NO in step S1601), the CPU 452 ends the processing of this flowchart.

In a case where the CPU 452 determines that the target ink tank has been mounted (YES in step S1601), the CPU 452 advances the processing to step S1602. Alternatively, in response to the target ink tank being mounted, an interrupt signal may be input to the CPU 452 from the consumable product mount/remove detection unit 461, and the CPU 452 may execute the processing in step S1602 and the subsequent steps.

In step S1602, the CPU 452 checks whether the date and time information is recorded in the start date of use 501 of the ink tank non-volatile memory of the target ink tank.

In step S1602, in a case where the CPU 452 determines that the date and time information is recorded in the start date of use 501 of the ink tank non-volatile memory (YES in step S1602), the CPU 452 ends the processing of this flowchart without updating the date and time information on the start date of use 501 of the target ink tank non-volatile memory.

In a case where the CPU 452 determines that the date and time information is not recorded in the start date of use 501 of the ink tank non-volatile memory (NO in step S1602), the CPU 452 advances the processing to step S1603.

In step S1603, the CPU 452 acquires the date and time information on the image forming apparatus 100.

In step S1604, the CPU 452 records the date and time information on the image forming apparatus 100 acquired in step S1603 in the start date of use 501 of the ink tank non-volatile memory included in the target ink tank, and then ends the processing of this flowchart.

As described above, according to the present exemplary embodiment, the notification miss (delivery request transmission miss) of requesting the consumable product delivery is prevented even with the device configuration in which the consumable product is easily removable. As a result, the occurrence of consumable product shortage is prevented.

According to the present disclosure, the notification miss of requesting the consumable product delivery and the occurrence of the consumable product shortage are prevented.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-019665, filed Feb. 13, 2024, which is hereby incorporated by reference herein in its entirety.

What is claimed is:

1. A printing apparatus including a display unit, comprising:
one or more memories storing instructions, and
one or more processors that execute the stored instructions, which cause the printing apparatus to:
record, in a case where a remaining amount of a recording material in a consumable product mounted on the printing apparatus is less than a first predetermined amount, notification-transmitted information indicating that a notification requesting a delivery of the consumable product has been transmitted, to a first storage unit included in the mounted consumable product, and externally transmit the notification;
record the information indicating that the notification has been transmitted as information on the mounted consumable product to a second storage unit included in the printing apparatus, based on the information recorded in the first storage unit; and
perform, in a case where the consumable product is removed from the printing apparatus, and the information indicating that the notification has been transmitted is not recorded in the second storage unit, display on the display unit of the printing apparatus indicating that the notification has not been transmitted and prompting a user to mount the consumable product on the printing apparatus.

2. The printing apparatus according to claim 1, wherein in a case where mounting of the removed consumable product on the printing apparatus is detected after the display is performed, in response to receipt of a user's selection indicating that the notification is to be transmitted, the notification is transmitted.

3. The printing apparatus according to claim 2, wherein in a case where mounting of the removed consumable product on the printing apparatus is detected after the display is performed, based on a fact that a difference between the remaining amount of the recording material in the consumable product and the first predetermined amount is less than a second predetermined amount, and in response to receipt of the user's selection, the notification is transmitted.

4. The printing apparatus according to claim 1,
wherein on the printing apparatus, the consumable product for each of a plurality of colors of recording materials is mounted, and
wherein, based on a determination of whether the remaining amount of the recording material in the consumer product of each of the plurality of colors is less than the first predetermined amount, the notification is transmitted for the consumable product of a color with the remaining amount of the recording material being less than the first predetermined amount among the consumable products of the plurality of colors.

5. A control method of a printing apparatus including a display unit, comprising:
record, in a case where a remaining amount of a recording material in a consumable product mounted on the printing apparatus is less than a first predetermined amount, notification-transmitted information indicating that a notification requesting a delivery of the consumable product has been transmitted, to a first storage unit included in the mounted consumable product, and externally transmit the notification;
record the information indicating that the notification has been transmitted as information on the mounted consumable product to a second storage unit included in the printing apparatus, based on the information recorded in the first storage unit; and
perform, in a case where the consumable product is removed from the printing apparatus, and the information indicating that the notification has been transmitted is not recorded in the second storage unit, display on the display unit of the printing apparatus indicating that the notification has not been transmitted and prompting a user to mount the consumable product on the printing apparatus.
